(19) United States
(12) Patent Application Publication
(10) Pub. No.: US 2011/0032349 A1
(43) Pub. Date: Feb. 10, 2011

(54) DEVICE FOR MONITORING SURFACE ALTERATIONS OVER TIME AND METHOD ASSOCIATED THEREWITH

(75) Inventors: Rafael Calonge San Matias, Barcelona (ES); Eloisa Velasco Ruiz, Barcelona (ES)

Correspondence Address: BARNES & THORNBURG LLP, 11 SOUTH MERIDIAN, INDIANAPOLIS, IN, 46204, US

(73) Assignee: CATFOSC. HEALTH MADE TO MEASURE, S.L., Barcelona (ES)

(21) Appl. No.: 12/937,043

(22) PCT Filed: Apr. 8, 2009
(86) PCT No.: PCT/IB2009/051483

§ 371 Date: Oct. 8, 2010

(30) Foreign Application Priority Data
Apr. 11, 2008 (ES) P200801027

(51) Int. Cl. H04N 7/18; G06K 9/00

(52) U.S. Cl. 348/128; 382/108; 348/E07.085

(57) ABSTRACT

A device for monitoring surface alterations over time, preferably skin alterations, has means for capturing images of the alterations and for storing same in a memory. The device includes a screen and a processor for processing and managing said images, and the aforementioned image-capture means includes at least two cameras with overlapping viewing angles. The processor is configured to process skin alteration images taken from different angles and to obtain therefrom an image of said skin alteration that corresponds to a pre-determined viewing angle, lighting type and level and distance.

The present invention refers to a device for monitoring surface alterations in the course of time, particularly cutaneous alterations, which permits to carry out a quantitative and objective monitoring of them in a simple way and with a reduced cost.

### BACKGROUND OF THE INVENTION

In the biomedical computing field there are well-known systems and methods for obtaining, treating, presenting and managing photographic and video images for applications in patient identification, for processing face images, fingerprints, e.g. in applications of plastic surgery, dermatology or odontology.

Generally, these systems present some of the following drawbacks:
they need complex, heavy and bulky devices to keep the same perspective, i.e. to obtain laboratory conditions, specially positioners and systems for generating a controlled illumination, which restrict their use to serious injuries or alterations, or to few patients for availability reasons, forcing them to move and they also imply a lot of limitations from a point of view of management of the obtained information,
or they are simple devices that only permit to carry out a superficial and qualitative management of the cutaneous alterations of the patients, and the user must define the outline,
or they are systems based in calibrated rulers for measuring distances, which are adhered to the skin of the patient on the cutaneous alteration, and then a photograph is taken.

In the first case they are complex devices, and therefore operated by specialists, which because of its relatively non usual use, they need a previous training and professional learning, they have user interfaces not very developed, because of its restricted use and consequent slow evolution, and they are not very intuitive. They are usually bulky and heavy and involve for its use the movement of the patients to the device. Therefore, as currently a specific device for each medical specialty is needed, its use to carry out the monitoring of any kind of alteration would be prohibitive due to the high cost it would generate. Another drawback of these devices is that there are a lot of products in the market, with different features, protocols and operation guides. Another drawback of these devices is that the positioning systems can involve a physical contact with the patient and, therefore, they are subjected with strict requirements from a hygienic point of view, with the additional costs it involves. Finally, there is no positioning device among those described that is not manual.

In the second case, they are devices, from which an example is Motion C5 from Intel Health, very spread in a lot of sectors, which just offer features for managing general information from different patients, so that the use of paper is avoided and they make the integrated computer management of the patients easier. These devices have cameras that permit to take photographs, generally of low quality, and to be associated with the medical history of a patient, but they are photographs that just permit to carry out a qualitative and subjective monitoring of the alterations, because it does not permit the quantitative comparison of their state between different instants.

It must be pointed out that in these devices it is not carried out any treatment of the image for its use in the medical treatment of cutaneous alterations, so that the valuation of the monitoring is subjective, i.e. it depends on the conditions in which the photographs are taken, and also on the moment in which they are evaluated and on the person that takes it, knowledge of the professional, external conditions, etc.

If a calibrated adhesive with a ruler is used, it permits a quantitative monitoring of the alteration, but however, it has the drawback that it is very slow, it only measures in two dimensions and it does not provide indications of the depth of the alteration, it is not very precise, specially due to the problems associated with the placement of the ruler, which is also disposable for hygienic reasons and depends on the subjective placement of that moment, i.e. its placement depends on the person who places it.

Furthermore, it is known, especially from U.S. Pat. No. 6,215,893, a device and a method for quantitative comparison of surface images of the skin in the course of time. Particularly, in this patent an algorithm for treating digitalized cutaneous images is described, with a poor recognition quality, VGA displays, with a very questionable result, even though it has the drawback that it needs a constant lightning source and it presents a user interface that is not practical and requires training by a specialist.

Therefore, currently there are no devices that permit to carry out said quantitative monitoring in the course of time of visible alterations, e.g. cutaneous, which can be used easily by medical staff and which makes easier the objective evaluation of the evolution of the alterations, and with an efficient and quick management of the medical history of the patients.

Therefore, the cutaneous alterations are very standardised and its high variety makes that only very experienced sanitary staff can take decisions quickly. This makes the establishment of protocols and actuation guides difficult, especially due to the great quantity of different devices, products, and methodologies, and therefore it results in lack of tools that helps to evaluate objectively and which can be able to advise and help the professional when he/she needs it, regarding the diagnostic and treatment. In this aspect, the biomedical computing and specifically the standardisation of the alterations by visual parameters, especially when it is integrated in a monitoring device of cutaneous alterations, can make the treatment possible by less qualified sanitary staff.

Therefore, it is desirable to provide a system that minimises the subjectivity and makes the monitoring of the process more objective, creating standard parameters, and providing an objective character to the greater number of parameters that characterise visually a cutaneous alteration.

### DESCRIPTION OF THE INVENTION

The present invention solves the drawbacks and the deficiencies of the state of the art, proposing a device and a method to carry out a monitoring in the course of time of alterations in objective surfaces, and in a simple way, and which also presents other advantageous features and characteristics that will be described hereinafter.

To this end, the present invention proposes a device for monitoring surface alterations in the course of time provided with means for capturing images of said alterations and storing them in memory, which comprises a screen and a processor for treating and managing said images, and it is characterised in that said means for capturing images comprises at least two cameras, whose vision angles are overlapped, and in which the processor is configured for processing and treating said images of the alteration in the surface taken from different angles and to obtain from them an image of the surface alteration corresponding to a vision angles, at a preset level and kind of illumination and at a preset distance.

Said combined features provide a device that solves the drawbacks of the state of the art, especially they permit, by the use of two cameras whose vision angles are overlapped, to obtain stereographical digital images of the surface alterations, and especially of cutaneous alterations, i.e. two simultaneous images from different angles, which, from a known image processing, permits to obtain virtual images as taken from the same position with respect to the alteration, i.e. the same perspective, and in the same conditions.

Therefore, when the device is used in sanitary environments, the user or different users of the portable device, generally sanitary staff, just places the device so that the cameras are approximately positioned with respect to the cutaneous alteration and takes the images.

Therefore, there are images of a cutaneous alteration corresponding to different instants, but which are comparable. This comparison, thanks to the use of cameras, preferably high definition cameras, and to the calibration system by stereographical composition, permits the comparison between images pixel to pixel (or equivalently, mm² a mm²), particularly from their colour, and to this end the processor will be provided with filters implemented by software to differentiate them.

It is thus obtained the equivalent to laboratory conditions even in extreme conditions, e.g. of massive influx of patients, in conditions of poor illumination, with patients that are not still, in completely adverse conditions as in the own residence of the patient with poor illumination and with a minimal space to work, and just with one operator.

Obviously, even though it has been described the particular case of cutaneous alterations, especially of any living being, the device of the invention can be used also for monitoring any altered surface to be monitored in the course of time.

It can have e.g. a especially advantageous application in the scope of monitoring alterations in walls due to damp or cracks, e.g. by experts and assurance companies.

Furthermore, thanks to its versatility, the device of the invention can be used in any applications related with the surface comparison between different moments, or the three-dimensional surface comparison with a pattern surface, as is the case of quality control of pieces.

It can be also useful in an assembly chain, stamping chain, in lithography preparation, etc.

In this last case, the device would permit to carry out the quality control of all the pieces, not being necessary to be perfectly and identically oriented, because the device of the invention permits to compare images taken from different points of view.

Preferably, the cameras are photographic cameras, which permit to obtain the two images necessary to obtain a stereoscopic vision of the altered surface in the simpler way.

More preferably, the cameras are video cameras, so that the image processor has several image pairs of the cutaneous alteration, which permits to tune up the precision of the elaboration of said images, by automatic selection of the most suitable one, which correspond to a preset vision angle, to a preset level and kind of illumination and to a preset distance. Furthermore, the image capture by video cameras permits to the sanitary staff that uses the device to obtain a greater control on the images it takes, permitting also, if necessary, to record video.

Advantageously, the screen is tactile/multitouch, so that the device of the invention does not need additional elements such as pencils or mousses, so that it is even easier the interface with the device. Furthermore, these additional elements, in a permanent use situation by several persons and in different places, are finally lost almost always. Therefore, it is guaranteed an availability of permanent use.

Preferably, the device is waterproof, so that it provides a more versatile use for the sanitary staff, which can place the hands in contact with liquids and be in environments in which it can be liquids that can spill.

More preferably, the device of the invention comprises spatial proximity localization means, such as RFID, so that the device permits to benefit from the information available about the specific situation of the patients in a medical centre, or in a hospital and, more concretely, to show in the screen the case of the patient in question, i.e. the medical history, when it is related with a determined space of said centre. This permits the sanitary staff who uses the device not to spend time looking for information related with the patient to be attended, and it also reduces the risk of confusions or medical errors because of administrative errors.

More advantageously, the device of the invention comprises means to project a plurality of laser beams over said surface alteration, which permit to form a mesh of points over the cutaneous alteration, which with the aid of cameras, permits to calculate the depth of the injury and complement the information collected by the cameras for reconstructing the images.

More advantageously, the device of the invention is adapted to monitoring surface alterations that are cutaneous alterations in living beings, human beings or animals or surface alterations in construction elements such as damps in walls, or any altered surface on which a monitoring in the course of time must be carried out.

The adaptation of the device to the different kinds of alterations consist in the correct election of the cameras, the distance between them and their optical properties.

Preferably, the cameras, the memory, the screen and the processor are integrated to configure a portable device.

Furthermore, it can be conceived a device composed by two parts, e.g. a part provided with both cameras and the screen, the processor and the memory elements being placed in a second part, which can be e.g. a computer.

Furthermore, it is also object of the present invention a method for monitoring surface alterations in the course of time, preferably cutaneous, in which a portable device provided with means for capturing images of the alterations and for storing them in memory is used, said device comprising a screen and a processor to process and manage the images, and it is characterised in that the means for capturing images comprises at least two cameras and in that it comprises a processing step of the captured images by both cameras in which, from the images taken from different angles by the cameras, an image of surface alteration corresponding to the vision angle is elaborated, at a preset level and kind of illumination and at a preset distance, so that it is possible to compare the state of the alteration between two or more different instants.

Preferably, the method for monitoring surface alterations in the course of time uses a device according to the invention and it comprises the steps of:

a) taking images of said surface with both cameras,

b) determining, from at least the image taken by one of the cameras, the outline of the alteration by an outline determination algorithm,

c) classifying, inside said outline, the pixels according to the colour range to which corresponds each pixel,

d) by combination of the images taken by both cameras, determining the area, the three-dimensional shape and the volume of the alteration,

e) by combination of the data obtained in steps c) and d), obtaining a three-dimensional representation of the alteration from a preset point of view.

Therefore, the determination of the volume and the three-dimensional shape of the surface alteration is carried out when its outline has been determined previously, which permits to reduce the calculation operations to the minimum necessary.

Finally, the method according to the invention comprises a previous calibration step that consists in photography simultaneously with both cameras a calibrated surface of known dimensions, so that the measures that are taken afterwards are done with a minimum precision necessary to carry out the monitoring in the course of time of the alterations. This permits specially to guarantee the quality of the measures along all the life of the device, and therefore it does not depend exclusively on a correct calibration of the cameras done in the factory.

### BRIEF DESCRIPTION OF THE DRAWINGS

For a better understanding of what has been disclosed some drawings are attached in which, diagrammatically and only as a non-limitative example, a practical case of embodiment is shown.

FIG. 1 is a perspective view of the device of the invention from the screen side.

FIG. 2 is a plan view of the device, in which the overlapping of the vision angles of the cameras that focus the cutaneous alternation can be seen.

### DESCRIPTION OF PREFERRED EMBODIMENTS

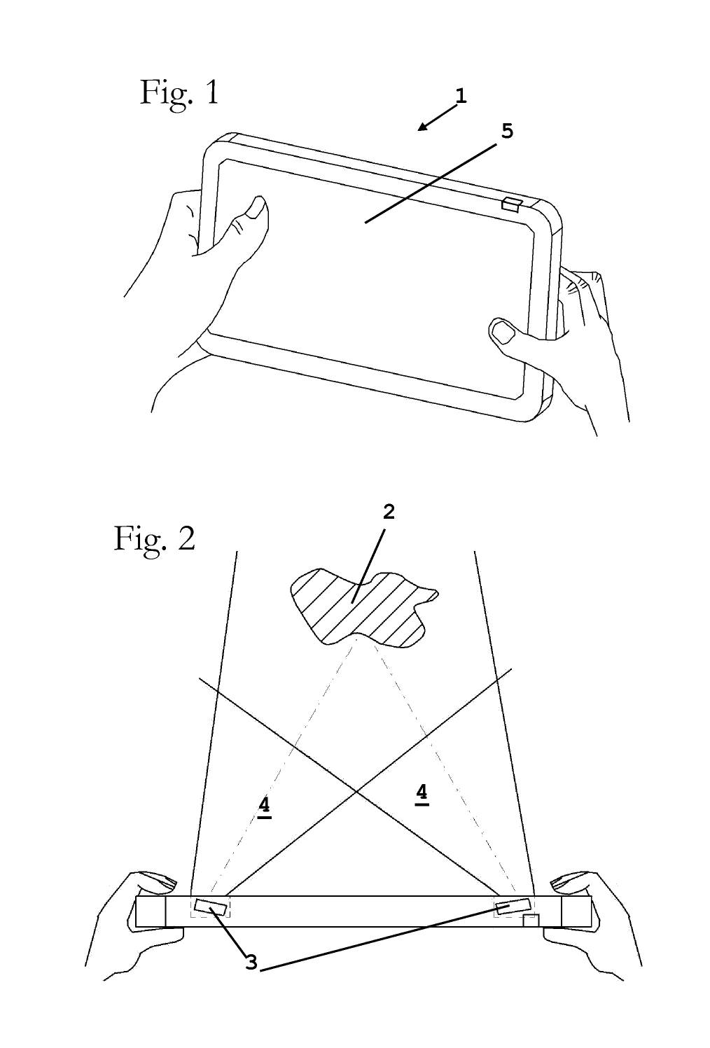

As shown in FIGS. 1 and 2, according to a preferred embodiment, the portable device 1 for monitoring cutaneous alterations 2 in the course of time of the present invention comprises two digital video cameras 3, whose vision angles 4 are partially overlapped, a screen 5 and a processor for processing and managing the images taken by them.

The quantitative monitoring of the cutaneous alterations is possible thanks to the processor configuration, which permits to process the images of the cutaneous alteration taken from different angles and to obtain from them an image of the cutaneous alteration that corresponds to a preset vision angle and to a preset distance.

Specifically, the processor is configured to reconstruct, from a pair of images of the cutaneous alteration, a three-dimensional model, from which a view will be selected that will form part of the images of the evolution in the course of time of the cutaneous alteration. This reconstruction can be done e.g. by the method described in article “MTMESH: Image Based Mesh Reconstruction and Rendering” of M. Sainz, N. Bagherzadeh and A. Susin.

Furthermore, this preferred embodiment presents the following additional features:
the cameras are video and high definition cameras,
the screen is tactile and it comprises only an on/off button apart from the tactile screen itself,
it comprises a neutral flash to take the capture of images in optimal conditions,
it can comprise two extendable handles or just one rear handle for one hand, to carry out the capture in stability conditions,
it comprises a support to carry out the charger function,
said support can comprise data transfer means to a centralised information system, which can be provided with a hard disk with a great capacity,
furthermore, said support can comprise a magnetic locking system driven by a card that identifies a user,
it includes a gyroscope, so that, independently from the orientation of the device, the image presented in the screen will be presented in a way that is functional for the user.

With said features, the device of the invention permits to treat, monitor, prevent, control, investigate and disclose, and also to:
Increase the clinical mobility and accessibility, which is nowadays very saturated and to decrease therefore the expenses in sanitary resources after the removal of duplicated works.
Decrease the hospital stay of the admitted patients and even to carry out the monitoring at home.
Reduce the time used by the sanitary staff.
Carry out an official medical registry. As the clinical histories, the collected information will have a legal validity and, to this end, the device provides a locking function that prevents the modification of the data introduced by the sanitary staff, said locking being done from a determined period of time from the moment in which the data are introduced, e.g. 24 hours.
Each registry, followed by text and images, can be used as defense for the professionals, preventing future legal lawsuits.
Establish a new information channel between the sanitary staff and pharmaceutical novelties of laboratories. The sanitary professional could know immediately the bibliography, previous studies and publications, information about products in use or to be used, different prices or presentations.
As they can be long evolution cures, which even can last years in being healed, the registry of the used methodology will be of greater importance, and being possible not only to carry out a personal valuation of the hundreds of existing products for the healing, very useful for the laboratories, but an economic registry of the used materials, which will be of great utility for the centre manager.

The device can be used in multiple fields, such as orthopedics, dermatology, and emergencies, in general surgery, plastic surgery, vascular surgery, in oncology, geriatrics and palliative care services.

What is claimed is:

1. A device for the monitoring of surface alterations in the course of time having means for capturing images of said alterations and for storing them in memory, comprising: a screen and a processor for processing and manage said images, wherein (i) said means for capturing images comprises at least two cameras with overlapping vision angles, and (ii) said processor is configured to process said images of the surface alteration taken from different angles and to obtain from said images an image of said surface alteration corresponding to a preset vision angle, a preset level and kind of illumination, and a preset distance.

2. The device of claim 1, wherein said cameras are video cameras.

3. The device of claim 1, wherein the screen is tactile.

4. The device of claim 1, further comprising proximity spatial locating means.

5. The device of claim 1, further comprising means for projecting a plurality of laser beams on said surface alteration.

6. The device of claim 1 wherein the surface alterations are cutaneous alterations in living beings, human, plants or animals, or surface alterations in construction elements.

7. The device of claim 1 wherein the cameras, the memory, the screen and the processor are integrated into a portable device.

8. (canceled)

9. A method for monitoring surface alterations in the course of time, comprising:
a) taking images of a surface by two cameras,
b) determining, from the image taken by one of the cameras, the outline of a surface alteration by an outline determination algorithm,
c) classifying, inside said outline, the pixels according to the color range corresponding to each pixel,
d) by combination of the images taken by both cameras, determining the area, the three-dimensional shape, and the volume of the surface alteration,
e) by combination of the data obtained in steps c) and d), obtaining a three-dimensional representation of the surface alteration from a preset point of view.

10. The method of claim 9, further comprises photographing simultaneously with both cameras a calibrated surface of known dimensions.

11. The device of claim 1, wherein said cameras are photographic cameras.

12. A device for the monitoring of surface alterations, comprising:
a screen,
a first camera configured to capture a first image from a first vision angle,
a second camera configured to capture a second image from a second vision angle overlapping with the first vision angle, and
a processor electrically coupled to the first camera and the second camera, the processor being configured to process the first image and the second image to obtain an image of a surface alteration corresponding to a preset vision angle, a preset level and kind of illumination, and a preset distance.
